(19) United States
(12) Patent Application Publication
(10) Pub. No.: US 2009/0281924 A1
(43) Pub. Date: Nov. 12, 2009

(54) LABEL IDENTIFICATION AND MANAGEMENT SYSTEM FOR FLUIDS

(75) Inventors: Michael Tony Kilian, Naperville, IL (US); Anthony James Farrell, Naperville, IL (US)

Correspondence Address: MCDONALD HOPKINS LLC, 600 Superior Avenue, East, Suite 2100, CLEVELAND, OH, 44114-2653, US

(73) Assignee: Reliability Brands LLC, Oswego, IL (US)

(21) Appl. No.: 12/396,444

(22) Filed: Mar. 2, 2009

Related U.S. Application Data
(60) Provisional application No. 61/067,676, filed on Feb. 29, 2008.

(51) Int. Cl. G06Q 30/00; G06F 3/048

(52) U.S. Cl. 705/27; 715/742

(57) ABSTRACT

A online label identification and management system for fluids is provided that reduces the incidence of improper fluids and lubricants being used on machinery and equipment at the enterprise.

### CROSS-REFERENCE TO RELATED APPLICATIONS

This application is generally related to U.S. Provisional Patent Application No. 61/005,975 entitled “FITTING COVER” filed on Dec. 10, 2007 and U.S. Utility patent application Ser. No. 11/801,821 entitled “SUPPLY CHAIN LABEL SYSTEM” filed on May 12, 2007.

### TECHNICAL FIELD

The present invention relates to an identification and management system for fluids, and more particularly, an on-line database driven Web, PC or PDA based system that creates, stores and manages customized fluid identification labels and attendant documents for accurately and uniquely identifying fluids when moving fluids from bulk storage, to intermediate container to the point of application on plant, equipment and machinery in residential, commercial and industrial applications.

### BACKGROUND OF THE INVENTION

Users of lubricants and other fluids currently face a very costly, fragmented and non-systemic problem in being able to quickly, accurately and uniquely identify their various fluids in a standardized format from bulk storage, to intermediate container, to point of use on plant, equipment and machinery in order to be in compliance with OSHA and other safety authority requirements while also considering the needs of the color blind or users who have a first language other than that which is the native language of the geographic location. The question then arises on how enterprise management can best handle this troublesome problem of moving fluids and in particular lubricant fluids about their facilities and yet keep their costs down so they can be competitive in a global marketplace.

For safety reasons as well as the proper application and use of the fluids and lubricants, it is important that the person dispensing the fluids or lubricants is able to identify the exact fluid or lubricant being used for a particular application. Often times due to the environmental and other conditions in a factory setting, the label properly identifying the fluid or lubricant for an application to products or equipment is missing information about the fluid in bulk storage, in the dispensing vessel or at the point of use on the equipment receiving the fluid or lubricant. Missing labels at any one of these points may result in damage to property, machinery or even to the person dispensing or working near the machinery in question. Also, if the fluid is spilled during dispensing, it is important to know how to deal with the spillage and what fluid was involved in the spillage. So in the industrial setting, a best practice fluid identification system is all but a necessity to increase profitability in the factory. Countless times, factory maintenance personnel are found to misidentify fluid containers or vessels and then misapply fluids or lubricants to machinery resulting in costly equipment failure or unnecessary downtime to fix the problem of the misapplication of the fluids including the costly repairs to the failed equipment or machinery.

At present maintenance people in various enterprises work in isolation to try and develop their own unique fluid identification conventions for use in their factory or other applications to ensure all fluids are accurately and adequately identified. This necessitates that you have maintenance people who have to create and attempt to source their own labels from a disjointed array of supply and material possibilities, all of which is not core to the nature of their business or competence. Does the enterprise really want their maintenance staff to create a fluid identification system which is hardly their core competence

Compounding this problem for larger multinational companies or organizations is their need to be able to standardize fluid identification conventions and practices across multiple facilities in multiple geographic locations worldwide. In short, the maintenance staff in these companies or organizations have no ability (or source) for a fully integrated, on-demand customized storage, management, creation and supply system for standardized Fluid ID labels. So it becomes obvious that there is need for a label identification and management system for fluids. Moreover, other requirements complicate matters such as attendant safety documents and support applications that need to be created and implemented for their own unique fluid identification labels that meet their particular dynamic requirements as and when required while also still endeavoring to meet the compliance requirements of governmental statutory safety authorities worldwide.

End users of any label identification and management system require an easily, readily and broadly accessible on-demand system for the centralized creation, storage, management and delivery of fluid identification conventions. Included in this on-demand system are the attendant fully customized fluid identification labels and the attendant supporting documents (such as Material Safety Data Sheets (“MSDS”), Product Data Sheets (“PDS”) or Hazmat/NFPA Labels etc.) for deployment locally or across multiple locations for the accurate identification and application of fluids from bulk storage, to intermediate container to point of use.

### SUMMARY OF THE INVENTION

According to the present invention, a label identification and management system for fluids is provided that reduces the incidence of improper fluids and lubricants being used on machinery and equipment at the enterprise. Beside incorporating by reference thereto U.S. Utility patent application Ser. No. 11/801,821 entitled “SUPPLY CHAIN LABEL SYSTEM” filed on May 12, 2007 as an example of the type of holder and mechanisms for holding a created label to identify the fluid or lubricant in use, the present invention includes an on-line (or local PC) based operating system that is driven by the maintenance personnel on the factory floor or by office support people at the company's headquarters offsite through an on-line or PC based secure interactive portal accessing inter-related databases.

The on-line system is accessed through the hardware and software of a computer through the typical browser on the local PC. The person seeking a particular label can get the following label templates:

a) Different size and styles of label templates (2.5″×3″, 3.25″×3.25″, 2″ Circle etc. . . . )

### b) Shapes

### c) Colors

### d) Icons and Graphics

### e) Fluid Manufacturer Names

### f) Fluid Names

### g) Fluid Viscosities

### h) Fluid Applications

### i) Fluid Types

### j) Free Text Fields

### k) Material Safety Data Sheets (MSDS)

### l) Product Data Sheets (PDS)

### m) Hazmat/NFPA Data

### n) HMIS Data

### o) Fluid Application Point Name & Location

### p) Fluid Application Point Number or Alpha/Numeric Identifier

### q) Fluid Application Point Type, Size or Geometry

### r) Fluid Application Point Service Temperature

### s) Fluid Application Point Quantity

### t) Unique Job Re-order Number

u) User Information and history
v) Supplier Information and history

### w) Pre-created Labels

x) E-commerce data

### y) Language Translation Templates

### z) Label Affixing Mediums and Components

The present label creating program at the server creates an easy to use labeling wizard that will a) sequentially step a User through a site fluid identification, application & data capture process from fluid bulk storage, to intermediate containers to points of use on machinery, plant and equipment. This will result in the User then having a blue print of each specific point on their site that requires labeling and identification for export into the wizard or 3^{rd} party on-site label installation routing software.

Further, the label wizard includes color and shape combinations. The color and shape combinations are used to create unique identifiers for a specific fluid. These unique identifiers are the basis of the chain of custody system that ensures the right fluid is transferred from the bulk storage containers to the correct transfer dispensing vessel, and then transferred into the correct fill points on the plant equipment and machinery. Shape and color combinations may be used at the following points within a factory setting: 1) at the fill point of the machinery; 2) machinery lube points; 3) Intermediate/transfer container; 4) bulk storage container and vessels; 5) MSDS sheet; 6) Product data sheet: 7) Safety/Hazmat/NFPA Label—Label—label templates enable the user to define the amount of information required from their unique labeling requirement so the shape and color combination can be applied to various created labels and Convention—a list of color and shape combinations related to predefined fluid criteria and the convention is applied to label templates and is used to pre-populate labels. Conventions are based amongst other things on the following: 1) viscosity of fluid; 2) fluid product; and 3) application. A label template incorporates the label design including size and content layout. The fluid library in the labeling wizard includes the customers list of fluids—with shape and color combinations pre-assigned. The label library contains the list of previously created labels.

So the wizard program on the server does the followings things:
a) Automatically create a suggested unique fluid identification convention for each of their specific fluids utilizing the wizard's information databases or the wizard will provide for a maintenance person to create their own identification conventions and thereafter store the data for that person's current and future use or to share it with others of his company.
b) Automatically generate a recommendation report to the person for:
   Required Fluid ID Labels: Quantity, Size, Convention etc. . . .
   Required Label affixing mediums (Paper, Adhesive, Laminate Plate etc.)
   Required supporting documents (MSDS, PDS, Hazmat etc. . . . )
   Site labeling location and implementation plan (what label goes where)
   Buy price, Ordering and Label/Material Delivery Options
      On-line via the wizard
      Local production on PC
      Via a wizard Reseller etc. . . .
   Store all of the above User's Data in a secure and searchable portal/database with re-order and reference criteria to enable future recall, reproduction or amendment of Labels etc. . . . by the User.
c) Integrate and interface its data with:
   a. Other websites
   b. PC's
   c. Handheld PDA's and Dataloggers
   d. Office based software data programs such as Excel.
   e. Other labeling systems
d) Enable User to do (among other functions) the following with their Fluid ID Labels and supporting applications:
   f. Search
   g. Store
   h. Share
   i. Create
   j. Deliver
      i. On-line
      ii. On-substrates of choice
      iii. On local PC or PDA or Datalogger etc
         Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is an overall flowchart of the system and process of creating labels in accordance with the present invention;

FIG. 2 is a flowchart of the label creation steps by an end user in accordance with the invention of FIG. 1

FIG. 3 depicts the labels created for the bulk storage of fluids, dispensing vessel of fluids and point of use of the fluids on machinery according to the invention of FIG. 1;

FIG. 4 shows a labeled bulk storage container and its corresponding dispensing can with labels created according to the invention of FIG. 1.

FIG. 5 shows a labeled fill point and a labeled dispensing can for a plant lubing process with labels created in accordance with the present invention;

FIG. 6 shows a fluid dispensing operation at the filler point on the factory equipment and a label holder attached to the filler point having labels created in accordance with the present invention;

FIG. 7 shows the various factory equipment with labeling identifying the lubricant to be used with labels created in accordance to the present invention;

FIG. 8 shows a grease nipple cover with a label identifying the lubricant on top thereof and a identification label tag both created in accordance with the present invention;

FIG. 9 shows a machine fill point summary lubrication legend created in accordance with the present invention;

FIG. 10 shows a screen shot of a label wizard program to create a label in accordance with the present invention;

FIG. 11 shows a screen shot of a label wizard program to create a label in accordance with the present invention;

FIG. 12 shows a screen shot of a label wizard program to create a label in accordance with the present invention;

FIG. 13 shows a screen shot of a label wizard program to create a label in accordance with the present invention;

FIG. 14 shows a screen shot of a label wizard program to create a label in accordance with the present invention;

FIG. 15 shows a screen shot of a label wizard program to create a label in accordance with the present invention;

FIG. 16 shows a screen shot of a label wizard program to create a label in accordance with the present invention; and

FIG. 17 shows a screen shot of a label wizard program to create a label in accordance with the present invention.

### DETAILED DESCRIPTION

While this invention is susceptible of embodiments in many different forms, the drawings show and the description describes in detail preferred embodiments of the invention with the understanding that the present disclosure is to be considered as an exemplification of the principles of the invention and is not intended to limit the broad aspect of the invention to the embodiments illustrated.

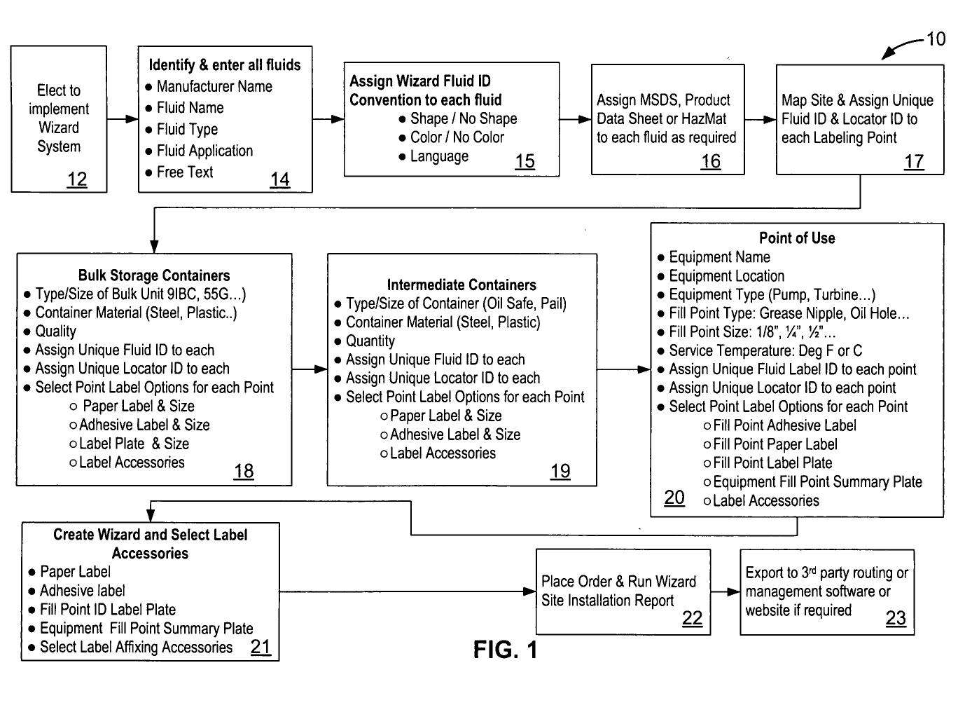

FIG. 1 illustrates an overall label wizard flow process for creating a label in accordance with the present invention. A person or end user attempting to create a label to identify its fluids as they travel from bulk storage in a plant facility and then in route to the machinery or equipment that is going to be lubricated needs a way to create labels that are usable with holders of various designs. Such holders and types of holders are shown in U.S. Utility patent application Ser. No. 11/801,821 entitled “SUPPLY CHAIN LABEL SYSTEM” filed on May 12, 2007.

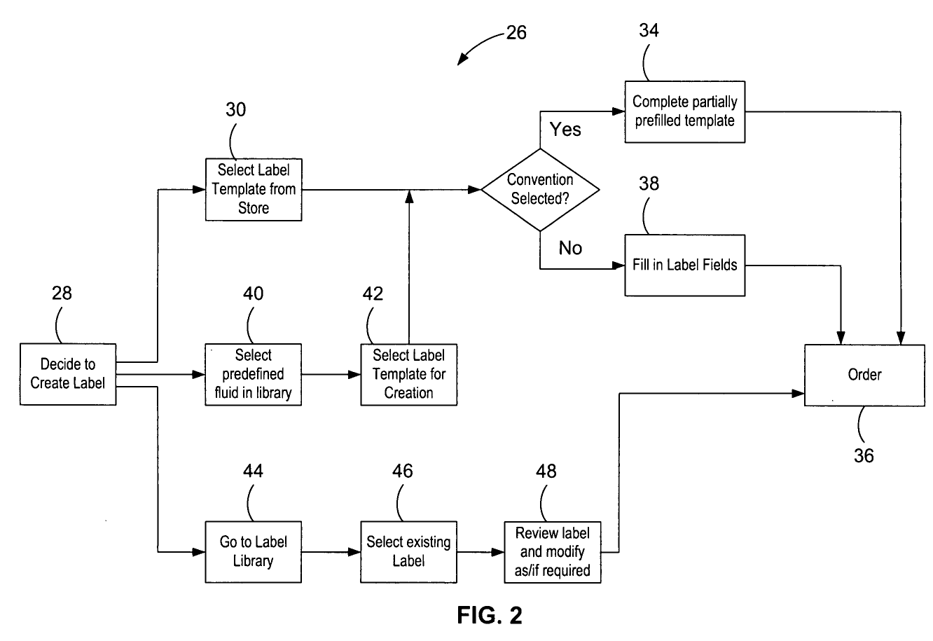

A label wizard creation system 10 is shown in FIG. 1 according to the invention. The system is comprise of a computer and a software program as outlined in FIGS. 1 and 2 that resides on a computer server accessible by an end user on the world wide web via a PC or other computing device that utilizes a typical browser program format. In the present invention, a label identification and management system for fluids, and more particularly, an on-line database and software program is driven by a Web, PC or PDA based system that creates, stores and manages customized fluid identification labels and attendant documents for accurately and uniquely identifying fluids when moving fluids from bulk storage, to intermediate container to the point of application on plant, equipment and machinery in residential, commercial and industrial applications.

A person or end user goes to their PC browser program and enters the web address of the label wizard creation system 10. The server sends a page to the user browser, which allows them to log into the system 10 after entering an appropriate ID and password if that becomes a requirement. The person then decides to elect to implement the label wizard system and goes through the following process in its program. A decision block 12 is an elect to implement wizard system. These blocks will further be explained later by actual screen shots from the web browser accessing the label wizard creator on a PC browser. Next a decision block 14 representing a screen shot of the html page allows the user to identify and enter all fluids required for the particular fluid application. The manufacturer name, fluid name, fluid type, fluid application and a free text box appears on the screen shot of the html page coming from the server hosting the label creating program. The user goes to decision block 15 then assigns a wizard fluid ID convention to each fluid such as the shape/no shape, color/no color and language to be used on the label. Next the user travels to the decision block 16 to assign MSDS, Product Data Sheet or HazMat to each fluid as required. The next step in the process is going to decision block 17 which is a Map Site and Assign of Unique Fluid ID and locator ID to each Labeling Point in a user factory site.

The process continues on to a bulk storage container decision block 18 where information concerning the bulk container such as steel or plastic etc is determined and appropriate and unique fluid and locator IDs are assign to each bulk container and labels of the appropriate type such as water resistant, adhesive, plastic etc are chosen given the type of fluids protected against.

Next, the process moves to an intermediate container decision box 19 where the intermediate or dispensing containers or vessels are assigned unique ID and Locator IDs and Point Label options for each point that they will be dispensing fluids is identified.

Finally, a point of use decision block 20 is next where labels are created to identify the equipment, equipment location, equipment type, fill point, fill point size and the labels are assigned again Fluid and Locator IDs. Options to the type of label material is chosen and an equipment fill point summary plate is created with various other label accessories being available. Again the labels are designed to fit within the holders for labels as described in the above-mentioned US patent application entitled Supply Chain Label System.

Then the user actually creates the labels and selected label accessories on the web page sent by the server and posted on his PC or other computing device as shown in decision box 21. Then the user places an order for the appropriately chosen labels and run the wizard site installation report to make sure that they have all of the necessary labels ordered for their particular facility and applications therein. Separately, the party holding the software on its server can export to a 3^{rd} party routing or management software or website if required by the end user. Some third party maybe hosting his information and it will be sent to that third party working with the end user. This is a typical situation for a number of manufacturing companies.

FIG. 2 depicts a series of logic blocks 26 that are three separate paths that can be taken that are showing the steps in creating a label according to the present invention with the label wizard system 10. A first logic block 28 shows the decision of the end user to create a label.

One path is to go to a Select Label Template from the store logic block 30 where the end user decides to use set templates for its label creation via its browser connecting to the server in the system 10 to create the labels. When going this route the user next travels to logic block 32, which is a Convention Selected box. From here there is a yes or no path to chose and if the user choice is yes they go to a Complete and/or Partially Prefilled Template logic block 34 for the label. If it is completely filled label then the next step is an order logic block 36. If the user choice is no then you go to a Fill in Label Fields logic block 38. The user fills in the pertinent information required on the label from a number of pull down menus covering all of the possible combinations of fluids, particular manufacturer of the fluids, the shape and color or any other accessories required to meet statutory or other requirements for labels in a particular geographic location where the label will be used.

A second path goes from logic block 28 to a Select Predefined Fluid library logic block 40 that feeds a Select Label Template for Creation logic block 42. That feeds to the same Convention Selected logic block 32 as path one and the remainder of the choices are exactly the same as path one.

A third path is from the decision block 28 to a Go To Label Library logic block 44. This library has a number of existing labels in the library so the next logic block is a Select Existing Label logic block 46 where the user selects an existing label with pre-filled information thereon. If the information needs to be modified the next logic block is a Review Label and Modify as/if Required logic block 48. If there is no modification required after review then the next block is the order logic block 36. If there is a need for a modification, the user can make those modifications to the label information and then go to order block 36.

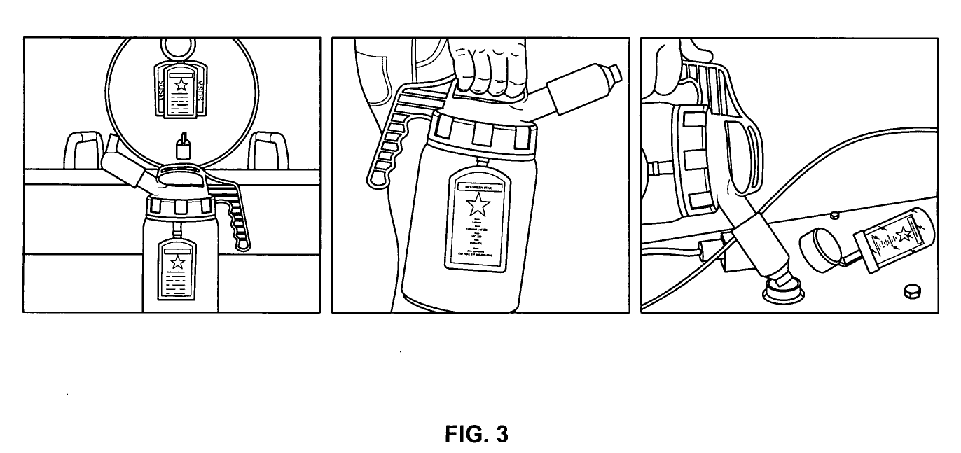

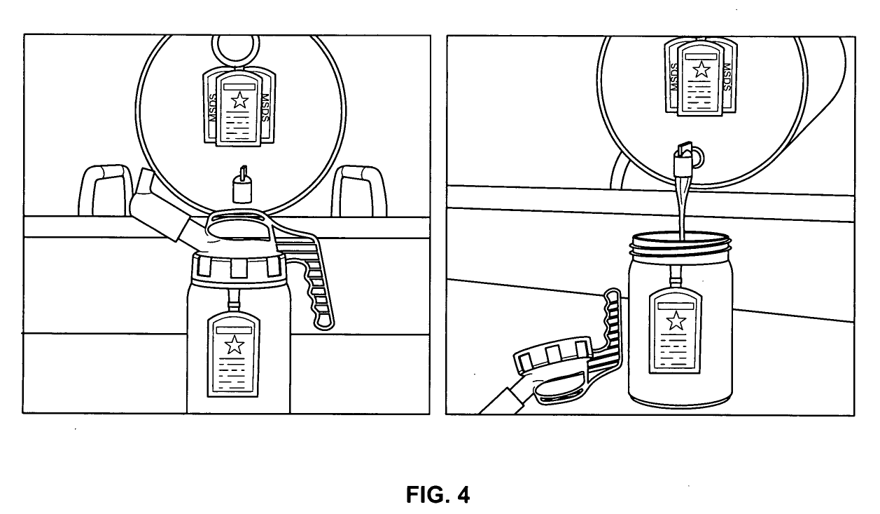

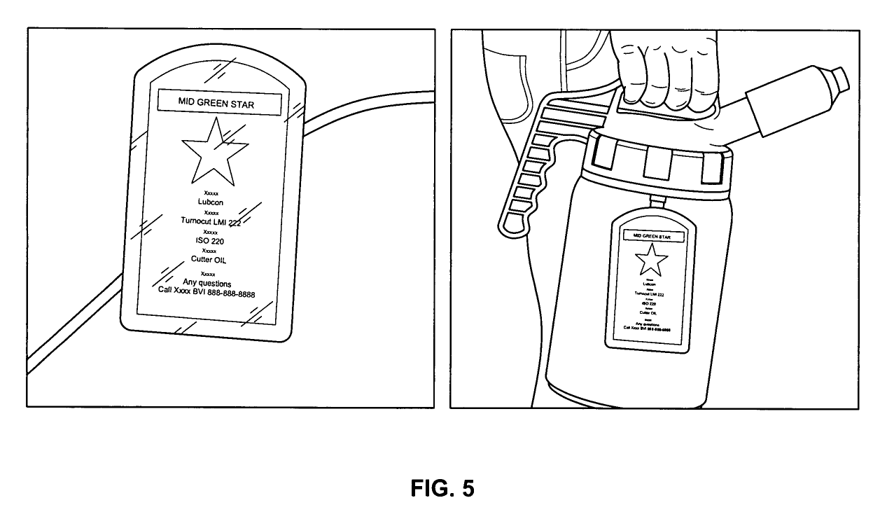

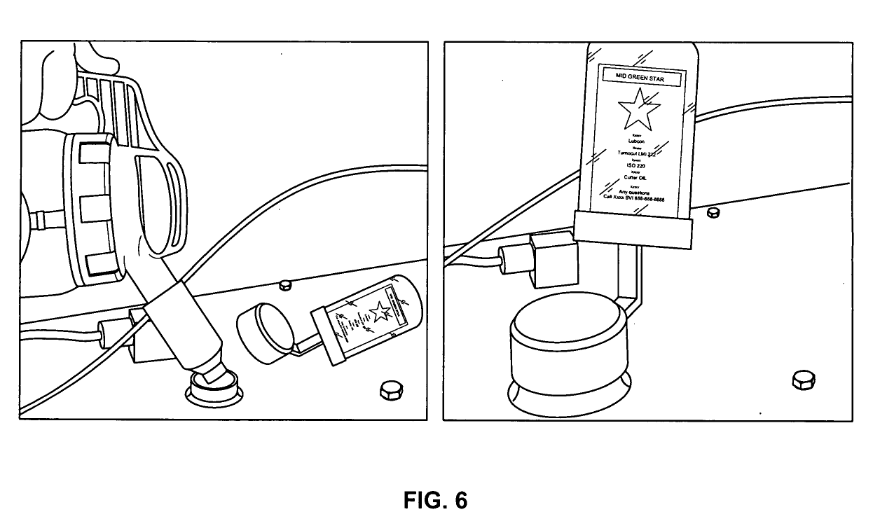

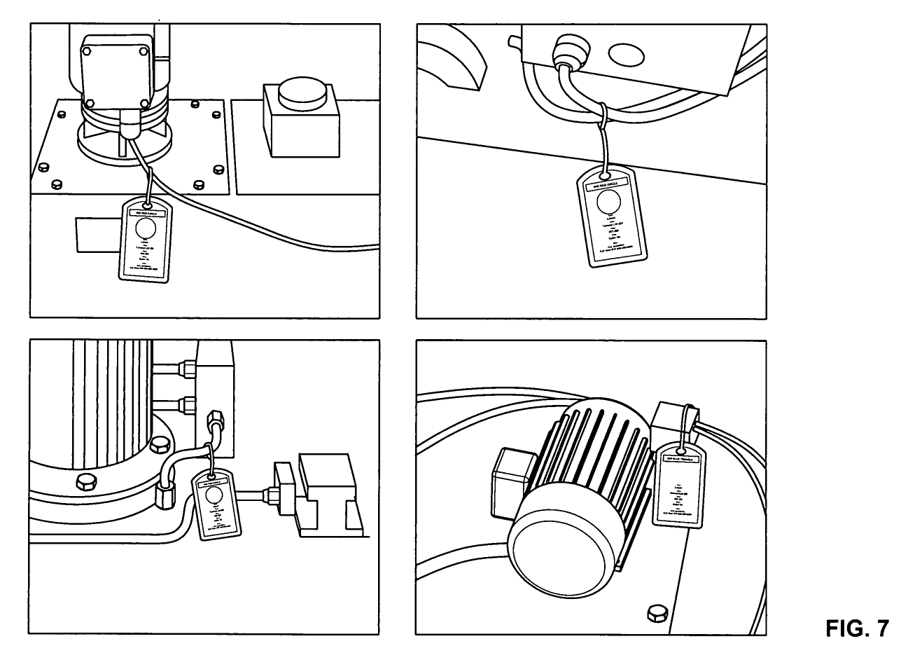

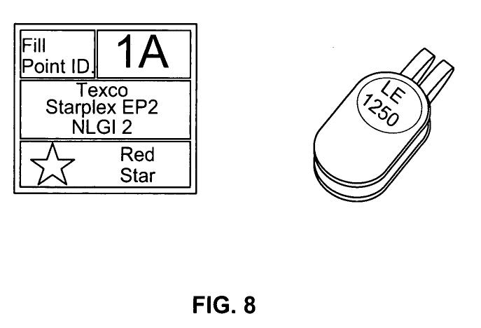

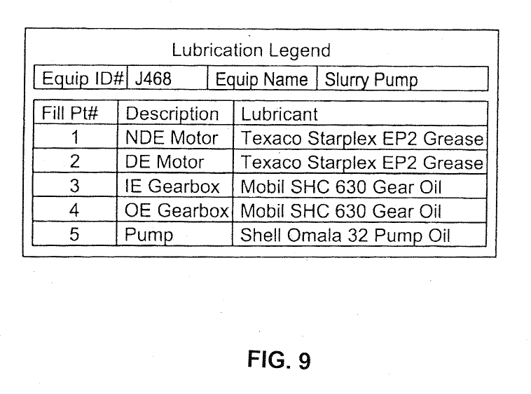

FIGS. 3-9 show the bulk containers, dispensing vessels and fill points on various machines and equipment typical found within factory settings. The FIGS. 3-9 also show the type of holders from the above-mentioned U.S. Utility patent application Ser. No. 11/801,821 entitled “SUPPLY CHAIN LABEL SYSTEM” filed on May 12, 2007 that go on bulk containers, dispensing vessels and machinery that hold the newly created labels off of the label wizard system 10.

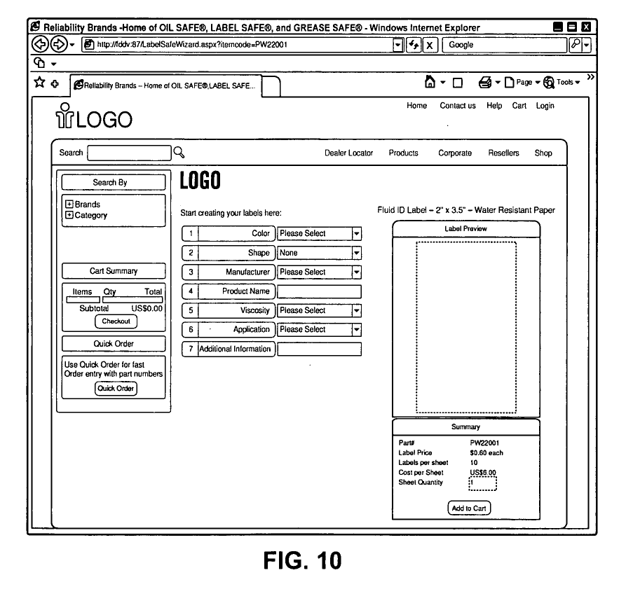

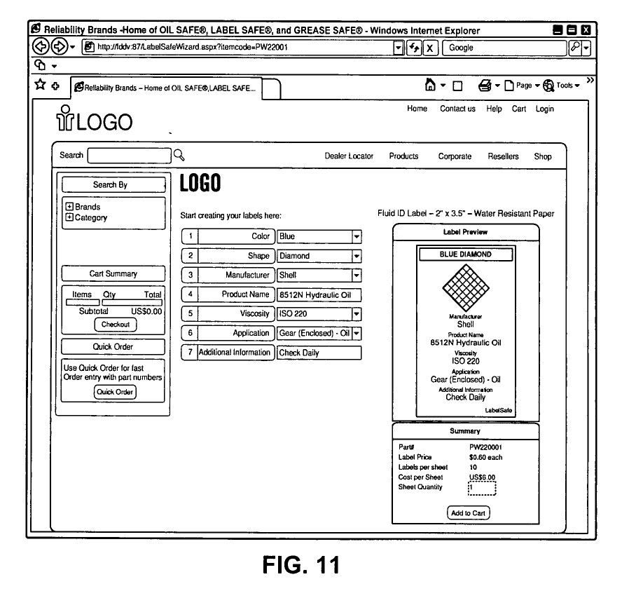

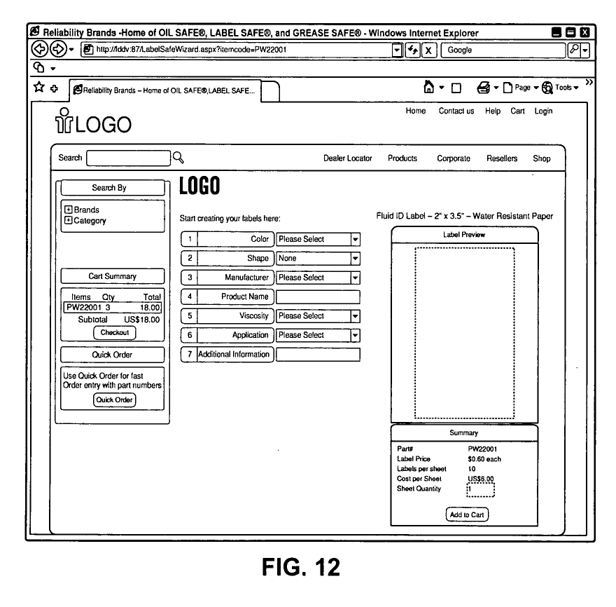

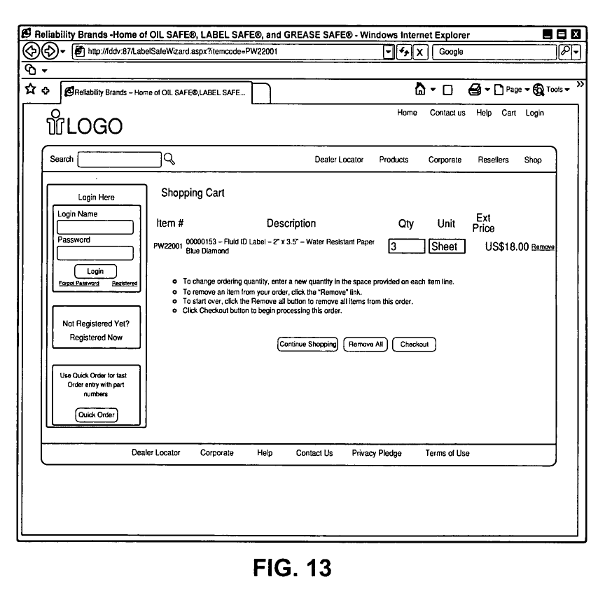

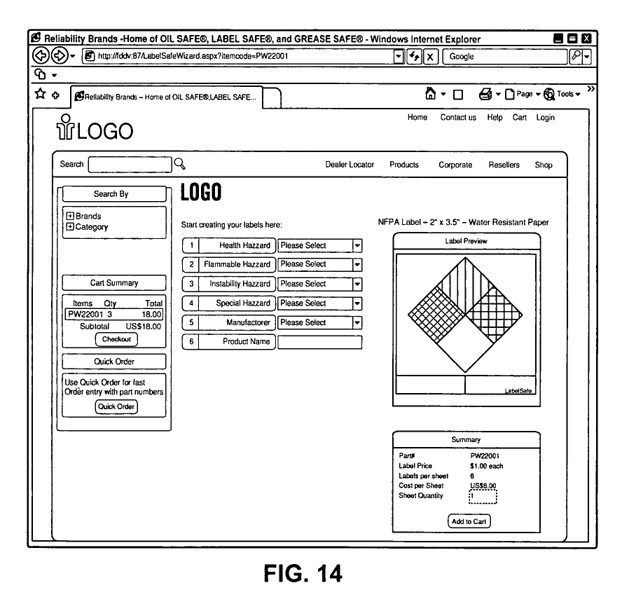

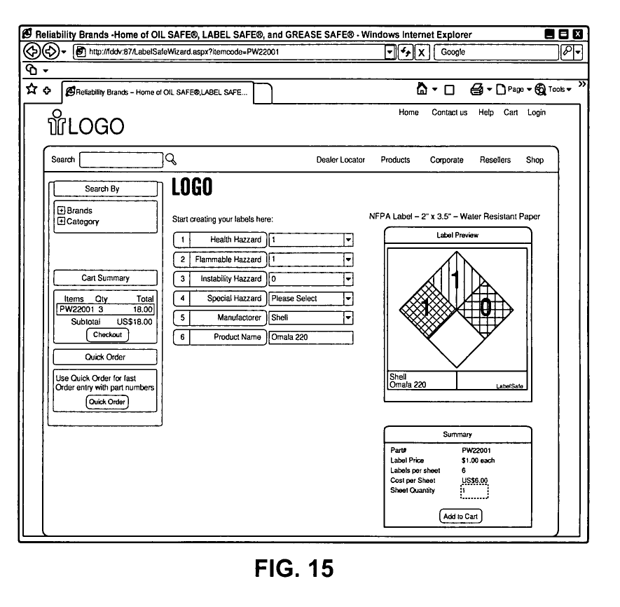

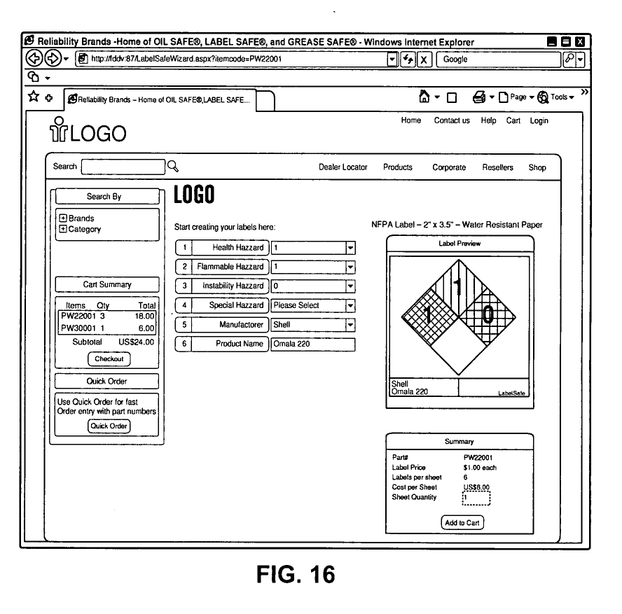

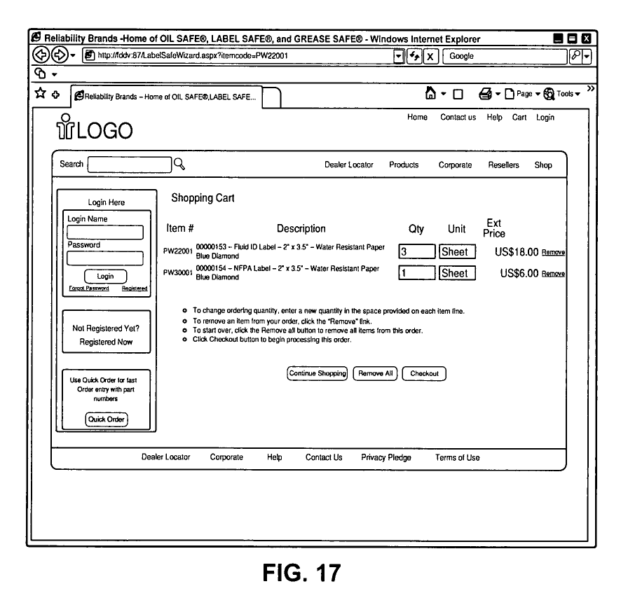

FIGS. 10-17 show the various screen shots of the html pages from the server with the label wizard program and how information is entered into the screens during as the user enters the appropriate information to create the proper identification labels and manage the labels used in his factory setting or any other location requiring proper label information on fluids to prevent the improper usage of those fluids. This system is ideal for organizing the chaos that many manufacturers and others face on a daily basis with their labels and dispensing of fluids.

The invention has been described above and, obviously, modifications and alternations will occur to others upon a reading and understanding of this specification. The claims as follows are intended to include all modifications and alterations insofar as they come within the scope of the claims or the equivalent thereof.

Having thus described the invention, we claim:

What is claimed is:

1. A label creating identification and management system for fluids, comprising:
a holder for holding a created identification label to identify the fluid or lubricant in use on machinery or equipment;
a PC based secure interactive portal for accessing inter-related databases connected to the Internet for accessing a label identification creating labeling system;
a selectable number of pull down menus for creating a fluid identification label associated with a predetermined fluid or lubricant for use with factory equipment or machinery;
and wherein on-line based operating system creates identification for fluids to reduce incidences of improper fluids and lubricants from being used on machinery and equipment at an enterprise.

2. The label system of claim 1, further including means for registering with the online database to secure label identification that are ordered online and shipped to address provided in pull down menus.
